(19) United States
(12) Patent Application Publication
(10) Pub. No.: US 2012/0308107 A1
(43) Pub. Date: Dec. 6, 2012

(54) METHOD AND APPARATUS FOR VISUALIZING VOLUME DATA FOR AN EXAMINATION OF DENSITY PROPERTIES

(76) Inventors: KLAUS ENGEL, Nurnberg (DE); ANNA JEREBKO, Erlangen (DE)

(21) Appl. No.: 13/487,171

(22) Filed: Jun. 2, 2012

(30) Foreign Application Priority Data
Jun. 3, 2011 (DE) 10 2011 076 929.3

(51) Int. Cl. G06K 9/00

(52) U.S. Cl. 382/131

(57) ABSTRACT

Properties of an object are visualized as an image on a display. In this way, the object is visualized using volume data. In accordance with slice information, at least one slice area is defined within the volume data. An image of a value region of the volume data is used for visualization on the display. The image is changed for the slice area in accordance with a distance of the slice area relative to a region of volume data bordering the slice area.

This application claims the benefit of DE 10 2011 076 929.3, filed on Jun. 3, 2011.

### BACKGROUND

The present embodiments relate to a method and an apparatus for visualizing properties of an object as an image on a display.

X-rays are widely used in medical diagnosis. The examination of female breast tissue for the formation of carcinomas may be carried out using x-rays (mammography), for example.

On account of the special anatomical conditions of the examined body region, special devices, which may be referred to as mammography devices, are used for such an examination using x-rays.

Recording settings of mammography devices have developed into standard settings for the diagnosis. The following two standard settings may be used.

The mediolateral oblique recording of the breast (MLO) (e.g., oblique recording) is the standard setting used in the early detection of breast cancer using mammography. The breast is recorded at a 45° angle. This 45° oblique recording is to visualize the outer, upper quadrants, the axillary branching and the inframammary fold.

In addition, the craniocaudal recording of the breast (e.g., CC recording) exists, which is implemented at right angles from above. The CC recording may show as much breast tissue as possible and visualizes all breast sections outside of the sections in the furthest lateral and axillary position.

A 2-plane mammography is in many cases implemented within the scope of a standard examination. The 2-plane mammography combines the mediolateral oblique (MLO) and the craniocaudal (CC) recording.

In spite of this combination of recordings from different angles, conventional mammography has its limits. There is the risk that tissue hardenings (e.g., calcifications) in the x-ray image are covered by other structures and are not diagnosed.

Tomosynthesis, which is used in digital mammography, for example, provides improved diagnosis possibilities. Conversely to computed tomography, this is based on only one comparatively small angular interval being scanned in the course of the movement of the x-ray tube around the object to be examined. The restriction of the interval may be determined by the object to be examined (e.g., female breast).

A sequence of tomosynthesis projections in mammography may be recorded by a modified mammography system or of a breast-tomosynthesis system. Twenty five projections are created, for example, while the x-ray tube above the detector moves in an angular range between −25° and 25°. During this movement, the radiation is released at regular intervals, and a projection is read out from the detector. A three-dimensional representation of the examined object is subsequently reconstructed in the computer from these projections in a tomosynthesis reconstruction process. This object may be in the form of gray scale values that visualize a measure of the density at the voxels or spatial points assigned to the gray scale values. In the course of the medical diagnosis, only the Z-layers of the reconstructed volume are in most cases observed (e.g., reconstructed slice images that are aligned in parallel with the detector plane).

An improvement in the observation of Z-layers may be achieved using visualization techniques for three-dimensional volume datasets.

Volume rendering techniques are used to visualize three-dimensional volumes as an image on a monitor. One volume rendering technique, which is referred to as direct, is, for example, ray casting (e.g., the simulation of beams penetrating the volume). In addition, multiplanar reformation, for example, which is also referred to as multiplanar reconstruction (MPR), exists. This is a two-dimensional image reconstruction method, in which raw data present as transversal slices is used to calculate frontal sagittal oblique or curved slices. The frontal sagittal oblique or curved slices assist the observer during the anatomical orientation. With the maximum intensity protection (MIP) method, the point from the 3D volume along the observational axis is imaged directly. The image includes the maximum gray scale value. A two-dimensional projection image appears. A spatial context thus develops when a series of MIP images is observed from different observer positions. This method is used in many cases to visualize structures filled with contrast agent.

The use of methods of this type for visualizing tomosynthesis data is described, for example, in the publications US 20100166267 A1, US 20090034684 A1, U.S. Pat. No. 7,760,924 and US 20090080752 A1.

In all these methods, account is to be taken of the fact that a large bandwidth with a different density (and thus a further range of gray scale values) may appear in the volume data present as gray scale values. To describe the reconstructed attenuation values, a scale that is named after the scientist Hounsfield and extends approximately from −1000 (e.g., for lung tissue) to 3000 (e.g., bones) may be used. A gray level is assigned to each value on this scale, so that a total of approximately 4000 gray levels to be visualized results overall. This diagram, which is usual in CT with three-dimensional image constructions, may not be easily transferred onto monitors used for visualization purposes. This is because a maximum of 256 (e.g., 2⁸) gray levels may be visualized on a commercial 8 bit monitor. Visualizing a higher number of gray levels is also not meaningful because the granularity of the visualization of the display already clearly exceeds the capabilities of the human eye, which may distinguish approximately 35 gray levels. In order to visualize human tissue, attempts are therefore made to extract the diagnostic details of interest.

With the ray casting method, density properties may be made more visible through the selection of transfer functions. Density or gray scale values may be mapped onto three colors in the form of a triple, which encodes the portions of color as red, green and blue (e.g., RGB-value) using an image referred to as transfer function. The imaging may also take place on an alpha-value that parameterizes the impermeability. Together, these variables form a color value RGBA that is determined during ray casting for a scanning point of a simulated beam and is combined or mixed with the color values of other scanning points to form a color value for a pixel of a display (e.g., for the visualization of partially transparent objects using alpha blending). In this way, for example, the alpha value determines which structures are visualized on the display. For example, deeper-lying calcifications may be concealed in the case of excessively high impermeabilities of fat and connective tissue. Accordingly, transfer functions are selected with respect to the visualization of the tissue structures of interest.

In addition to selecting the transfer function, a suitable adjustment of the visualization of the object may be needed in order to improve the study of properties of an object visualized using volume rendering. The visualization of the object visualized on a monitor may be changed or influenced (e.g., by parts of the object being colored, removed or enlarged). The terms volume editing and segmentation are used for manipulations of this type. Volume editing also relates to interventions such as clipping, cropping and punching Segmentation allows for the classification of object structures, such as, for example, anatomical structures of a visualized body part. In the course of the segmentation, objects are colored or removed, for example. The term direct volume editing relates to the interactive editing or influencing of the object visualization using virtual tools such as brushes, chisels, drills or knifes. For example, the user may interactively change the image of the object visualized on a monitor by coloring or cutting away object parts using a mouse or another haptically or differently functioning input device.

With a processing of the visualized object of this type, it may not be sufficient to change the calculated pixels of the object image but instead a recalculation of pixels is to take place. In other words, with many manipulations of this type (e.g., coloring, clippings), the volume rendering or ray casting is to be implemented once again with each change.

With this procedure, the diagnosis of malign changes being a complex undertaking may be taken account of. Accordingly, many larger calcifications are benign, and smaller micro-calcifications suggest the formation of a tumor. For improved diagnosis, the physician uses as much relevant information about the region of the soft tissue changes and the embedding of the changed tissue in the surrounding tissue layers as possible.

### SUMMARY AND DESCRIPTION

There is a need for methods of influencing objects visualized by volume rendering that provide information relevant to assessing object properties. The present embodiments may obviate one or more of the drawbacks or limitations in the related art. For example, a change in the visualization of volume data, which enables an improved examination of properties of the volume data, is provided for medical diagnosis.

In one embodiment, a volume data record, which was obtained or reconstructed, for example, with the aid of measurements using a medical modularity (e.g., x-ray apparatus, computed tomography, nuclear spin tomography, ultrasound). The volume data record is used to visualize an object assigned to the volume data record. The visualization on a display or a monitor may be performed, for example, using ray casting or simulated beam incidence. Provision is made to change the visualization for the examination of properties of the object. For this purpose, slices that change a region of the volume data (e.g., slice area) in accordance with slice information may be implemented. The slice information may be automatically generated in this way or input by a user. In the slice area, the visualization is influenced by an image of a value range of the volume data. This image is a transfer function (e.g., ramp function), for example, such as is used, for example, in ray casting. The transfer function may be moved or distorted on the axis of the argument such that density values are shown differently (e.g., more transparently than in the remaining volume). With this procedure, the image for the volume data of the slice area is changed in accordance with a distance (e.g., in accordance with the smallest distance) of the slice area relating to a region of the volume data bordering the slice area (e.g., in accordance with the distance from the edge of the slice area). For example, volumes may be visualized more transparently for a value range of the volume data, the greater the distance from the edge. This transparency of the visualization that falls toward the edge may be both a monotonous and also a strictly monotonous fall.

The present embodiments develop editing techniques that may be used during rendering. The editing techniques allow for the pure removal of object areas (or in medical tissue), with the further aim of all information of the area affected by the editing no longer being lost. Volume properties of the object are taken into consideration for the visualization at least at a certain, predeterminable distance of the slice surface, or the object processed by slicing is not visualized at the predeterminable distance of the slice surface as completely transparent. In one embodiment, transparency may increase with an increasing distance at least in a specific density range. Densifications or hardenings appear more clearly in this area, without the entire surrounding or contextual information getting lost. A type of “melting away of tissue” or “tissue thinning” takes place, which assists with the diagnosis.

From a certain threshold spacing, the object processed by the slicing is visualized as completely transparent (e.g., from this point, as with conventional cutting, the object material is completely exposed in the visualization). In this embodiment, a distinction may be made, in accordance with a deeper slice, between three zones of the visualized object (e.g., the outermost, where the object was completely exposed or is visualized as completely transparent, a transition zone, which extends from the slice area outwards, where material (e.g., normal or dominating material in a prevailing density range) is visualized transparently, and an area unaffected by the slice in which the visualization remains unchanged). The slices may be of any shape (e.g., spherical, v-shaped or planar). If, as with tomosynthesis, a direction is given, in which the volume data exists with lower resolution by comparison with the vertical direction, a visualization is performed with a line of sight essentially (e.g., up to 10°) at right angles to the direction with a lower resolution.

In one embodiment, different slices (e.g., a plurality of slices) are automatically performed and stored in this form. The specification of the different slices may take place in accordance with object properties (e.g., shape, anatomy). An image sequence that may be stored for further uses is then produced. This image sequence may, if necessary, be read out from the memory and studied. This procedure is advantageous in that the work with the image sequence uses considerably fewer resources in terms of computing power and storage volume than that of the actual rendering or the obtaining of visualizations. For example, an image sequence of this type may also be used effectively for remote diagnostics, since the restricted data volume of the image sequence allows for transportation across larger distances. Alternatively, slices are not automatically predetermined but are instead input by the user by slice information. This may take place with an input device like a mouse or a keyboard. The respective recalculation after one slice may take place “on the fly” or interactively (e.g., by direct rendering) in the case of the user input.

The present embodiments also include an apparatus and a computer program that are embodied to implement one embodiment of a method. The computer program may be stored in a non-transitory computer-readable medium and may store instructions executable by a computing device to visualize properties of an object as an image on a display.

### BRIEF DESCRIPTION OF THE DRAWINGS

FIG. 1 shows a side view of one embodiment of a mammography device

FIG. 2 shows a front view of one embodiment of the mammography device according to FIG. 1;

FIG. 3 shows two exemplary deflection positions during the irradiation by a mammography device during tomosynthesis;

FIGS. 4a and 4b show one embodiment used in a breast examination;

FIG. 5 shows an exemplary v-shaped slice;

FIG. 6 shows an exemplary spherical slice; and

FIG. 7 shows a flow chart of one embodiment of a method for visualizing properties of an object as an image on a display.

### DETAILED DESCRIPTION OF THE DRAWINGS

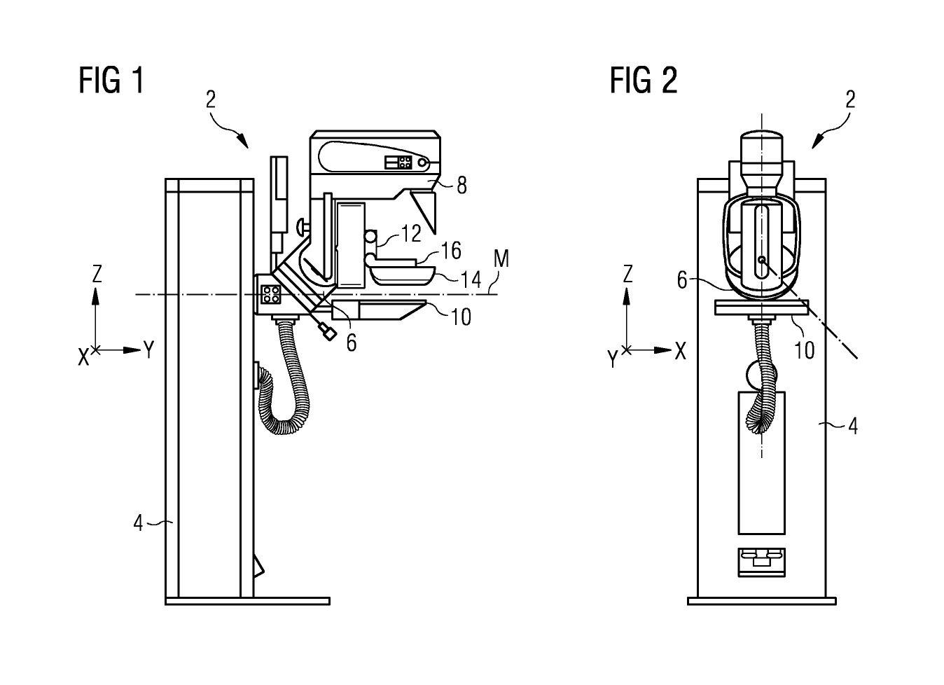

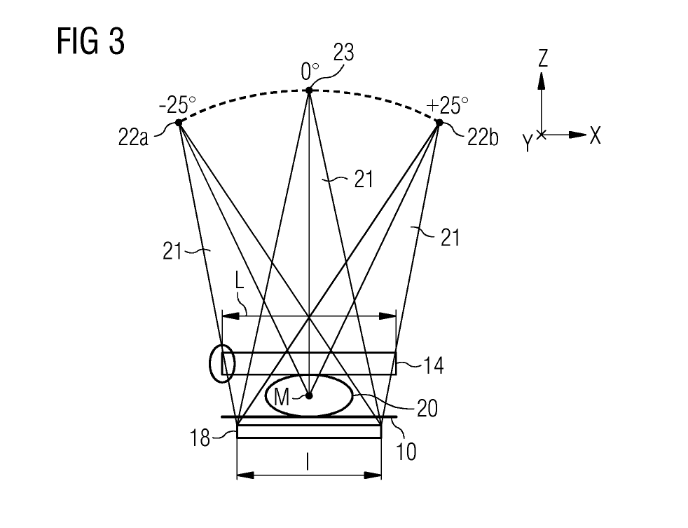

A side view and a front view of a mammography device 2 are shown in FIGS. 1 and 2, respectively. The mammography device 2 includes a base body embodied as a stand 4 and an angled device arm 6 projecting from the stand 4. An irradiation unit 8 embodied as an x-ray emitter is arranged at a free end of the angled device arm 6. An object couch 10 and a compression unit 12 are also mounted on the device arm 6. The compression unit 12 includes a compression element 14 that is arranged in a displaceable fashion relative to the object couch 10 along a vertical Z-direction. The compression unit 12 also includes a support 16 for the compression element 14. A type of lift guide is provided in the compression unit 12 in order to move the support 16 together with the compression element 14. A detector 18 (see FIG. 3) is also arranged in a lower region of the object couch 10. The detector is a digital detector in this exemplary embodiment.

The mammography device 2 is provided, for example, for tomosynthesis examinations, in which the radiation unit 8 is moved through an angular range about a central axis M running in parallel to the Y-direction, as apparent from FIG. 3. A number of projections of the object 20 to be examined, which is held in a fixed position between the object couch 10 and the compression element 14, are obtained. With the image recordings from the different angular positions, a cross-sectionally conical or fan-type x-ray beam 21 penetrates the compression element 14, the object 20 to be examined and the object couch 10 and strikes the detector 18. The detector 18 is dimensioned such that the image recordings may be taken in an angular range between two deflection positions 22a, 22b at corresponding deflection angles of −25° or +25°. The deflection positions 22a, 22b are arranged in the X-Z plane on both sides of a zero position 23, in which the x-ray beam 21 strikes the detector 18 vertically. In this exemplary embodiment, the planar detector 18 has, for example, a size of 24×30 cm.

Upon traversing of the path from point 22a to point 22b, 25 recordings, for example, are taken. The examined object 20 is reconstructed from the recorded projections.

The reconstructed object may be present in the form of density values provided at voxels or spatial points that visualize a measure of the respective density. In order to visualize object properties, pixel values for visualization on a monitor are generated from gray scale values.

The procedure of the present embodiments is illustrated in more detail with the aid of tomosynthesis data. It is assumed, for example, that a volume rendering is performed using ray casting. In the course of the ray casting, transfer functions are used. The transfer function assigns optical properties to the data values of the volume data record, with which the data values are visualized in the rendered image. For example, transfer functions assign a color and opacity (e.g., α-channel) to each value of the volume data record. Identical values of the volume data record receive the same color and the same opacity. For improved visual representation, the opacity may be modulated not only with the data value but also with the gradient magnitude in order to highlight edges or surfaces more clearly. The gradient magnitude corresponds to the sum of the gradient vector, which points in the direction of the most significant gradients from the data value of a voxel to the data values of an adjacent voxel.

With transfer functions, in which color value and opacity vary, reference is also made to RGBA transfer functions. For improved illustration, a transfer function T_{RGBA} (x), which uses only the volume value or density value as an argument, is subsequently assumed. This function assigns RGBA values to the volume value x. Only the opacity A or α may be varied in the course of a “melt down.” The respective location x corresponds to the scanning points of the beams used during ray casting. These scanning points are obtained from the volume data. With the visualization of soft tissue, ramp functions may be used. This is assumed for the following discussion for greater clarity. Within the scope of the ray casting, color values and opacities are accumulated along the beam in order to generate a color and opacity for the resulting pixel on the monitor. For the melting away of tissue of the present embodiments, the transfer function is moved to the x-axis in accordance with a distance d of the scanning point relative to a boundary defined by a slice. The distance relative to the boundary may be scaled with a constant factor t and imaged with a “Clamp” function in the [0.1]-region (e.g., ds=Clamp(t*d, 0., maxOffset)). The maximum offset (maxOffset) is a parameter that defines the distance from the boundary, from which tissue is visualized as completely transparent. The change in the visualization or transfer function may be performed such that for a scanning point s, the entire transfer function or only the part describing the opacity is taken at location x=s−ds instead of at location x=s. As defined above, ds is a measure of the distance from the boundary. In the first instance, the RGBA value used is given by T_{RGBA}(s−ds) and in the second instance (only change in opacity), by T_{RGB}(s) and opacity T_{A}(s−ds). With a ramp function, this operation corresponds to a displacement of the ramp function in accordance with the distance from the edge.

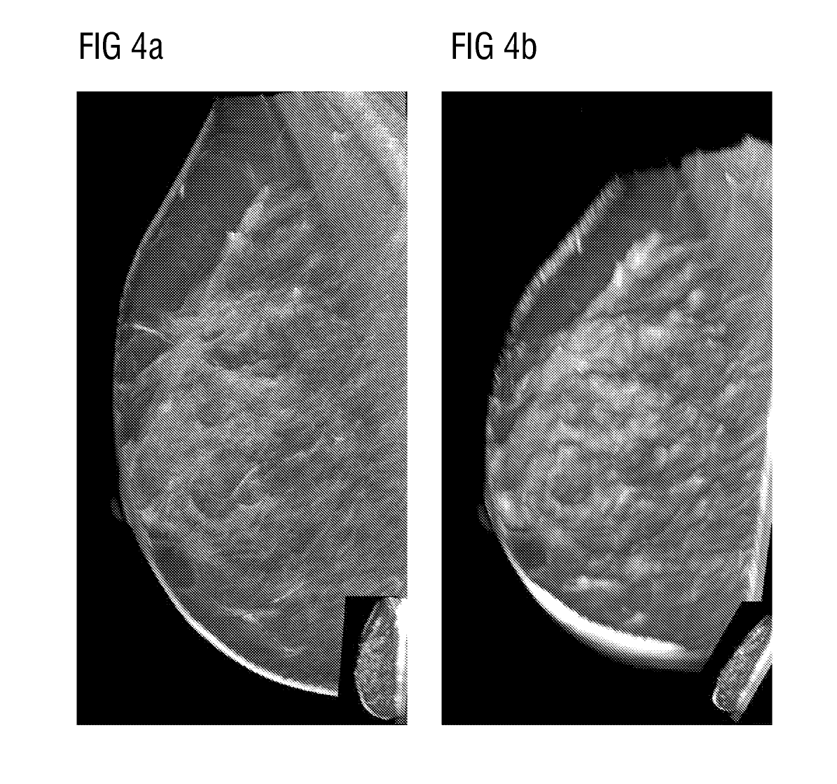

In the case of breast examinations using mammography, this procedure leads to a type of simulated melting, in which denser soft tissue is melted more slowly than soft tissue with a lower density. Density properties are therefore shown as three-dimensional structures in the vicinity of the boundaries generated by the slices. In other words, the density material forms projections and depressions on the boundaries of the slice areas. This is shown with the aid of the figures. For a planar slice with a corresponding planar boundary, the effect of the melting-away of soft tissue is shown in FIGS. 4a and 4b. FIG. 4a shows an almost orthogonal view to the xy plane of digital breast tomosynthesis data. FIG. 4b shows the same data record after rotation into a more oblique position. The denser tissue, such as masses and vessels, forms mounds and depressions. In other words, the three-dimensional form of such structures may be detected. Moving the positions of the planar border surface enables the user to negotiate the entire volume data record and reconstruct 3D structures with any density.

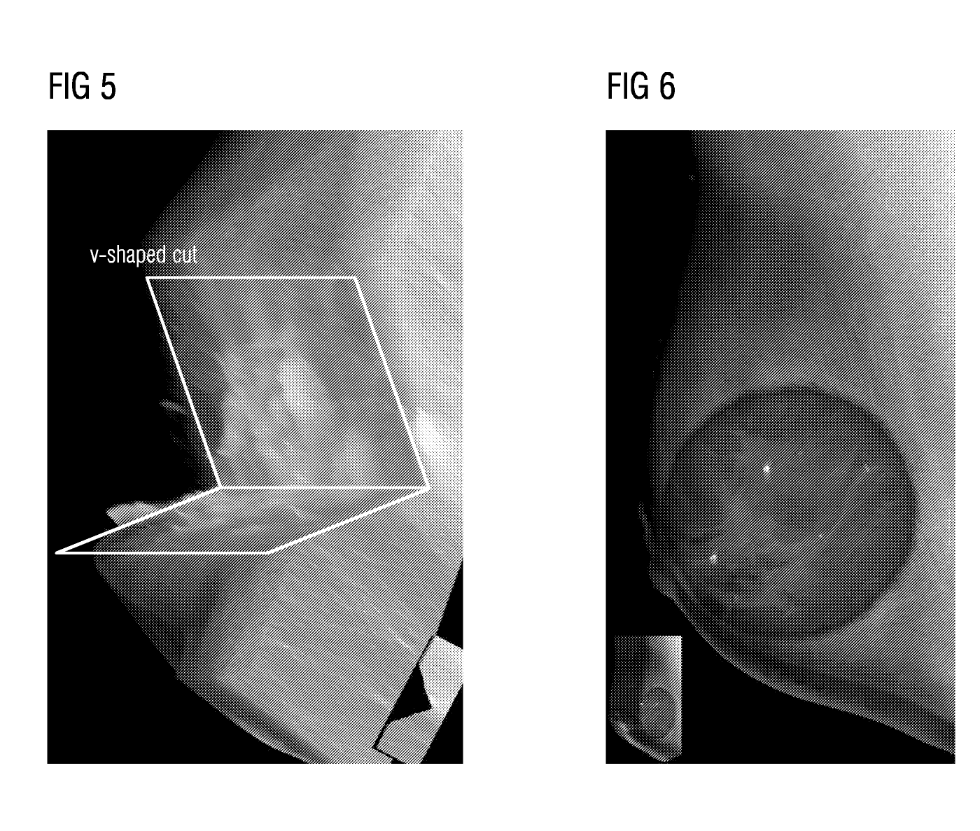

Other slice geometries (e.g., a v-shaped slice (FIG. 5) or a sphere (FIG. 6)) may be used. A typical user scenario for a spherical slice would allow a user to guide a spherical slice area across or through the soft tissue. In this way, structures with more dense material appear and disappear, again provided the slice area is guided further. These structures are localized at the edge of the slice area in each instance. This guidance of slices or movement of slices through the object may take place automatically or in a user-controlled fashion.

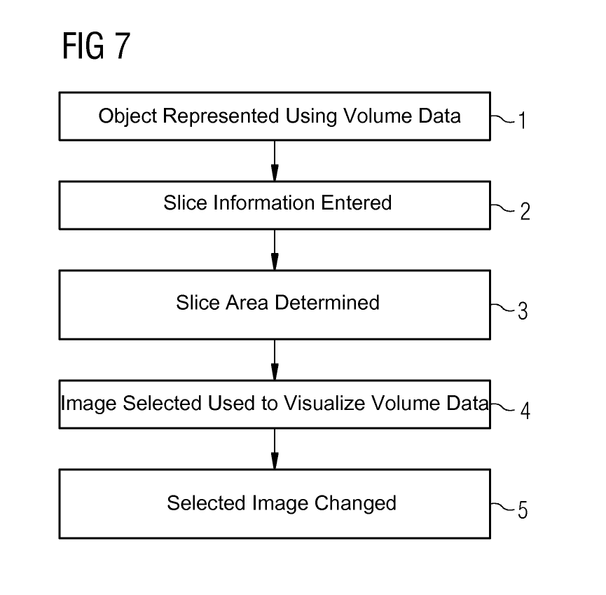

FIG. 7 shows a flow chart for central components of one embodiment of a method. A volume is shown with the aid of volume data (act 1). Slice information is entered in order to change the visualization of the volume (act 2). A slice area is determined in accordance with the input slice information (act 3). An image selected is used to visualize volume data (act 4). This image is changed according to the distance from points of the slice area to the slice area edge. As a result, information relating to the surroundings of the slice area edge may be better visualized. The acts may be performed at least partially in another sequence.

The invention is described for tomosynthesis data within the scope of the exemplary embodiment. The invention is not restricted to this case, but may instead be used to visualize any objects present as voxels. Aside from medical applications, industrial applications (e.g., material examinations) may also be considered, for example.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for visualizing properties of an object as an image on a display, the method comprising:
visualizing the object using volume data;
defining at least one slice area in accordance with slice information within the volume data;
using an image of a value range of the volume data for visualization on the display; and
changing the image for volume data of the at least one slice area in accordance with a distance of the at least one slice area relative to a region of volume data bordering the slice area.

2. The method as claimed in claim 1, wherein the image is changed such that the object is visualized more transparently the greater a distance, for at least one value range of the volume data.

3. The method as claimed in claim 2, wherein the increase in transparency of the visualized object is implemented in accordance with the density.

4. The method as claimed in claim 1, wherein the object is visualized using ray casting.

5. The method as claimed in claim 1, wherein the image is produced in the form of a transfer function.

6. The method as claimed in claim 5, wherein the transfer function has the form of a ramp function.

7. The method as claimed in claim 5, wherein the transfer function is moved in accordance with a distance of an argument from a bordering area at least for arguments having a minimal distance from the bordering area that does not exceed a maximum distance.

8. The method as claimed claim 1, wherein with distances that are greater than a threshold value distance, the object is visualized as completely transparent.

9. The method as claimed claim 1, wherein the volume data is obtained using tomosynthesis.

10. The method as claimed in claim 1, wherein a slice area of the at least one slice area is defined according to a spherical, v-shaped or planar section.

11. The method as claimed in claim 1, further comprising identifying a direction, in which the volume data exists at a lower resolution by comparison with vertical directions, wherein a visualization with a viewing direction essentially at right angles to the direction of the lower resolution is performed.

12. The method as claimed in claim 1, wherein in accordance with object properties, the slice information is automatically defined or determined within the scope of a presetting, and wherein at least one section correlating to the information is automatically implemented.

13. The method as claimed in claim 12, further comprising generating and storing a sequence of images with differing slices.

14. The method as claimed in claim 1, wherein the slice information is inputtable by a user using an input device.

15. The method as claimed in claim 14, further comprising generating, by a user, a recalculation of the image based on an input from the slice information.

16. The method as claimed in claim 2, wherein the object is visualized using ray casting.

17. The method as claimed in claim 2, wherein the image is produced in the form of a transfer function.

18. An apparatus to visualize properties of an object as an image on a display, the apparatus comprising:
a computing device configured to:
visualize the object using volume data;
define at least one slice area in accordance with slice information within the volume data;
use an image of a value range of the volume data for visualization on the display; and
change the image for volume data of the at least one slice area in accordance with a distance of the at least one slice area relative to a region of volume data bordering the slice area.

19. The apparatus as claimed in claim 18, wherein the computing device comprises:
a function module for visualizing the object using the volume data,
a function module for defining the at least one slice area within the volume data in accordance with the slice information;
a function module for using the image of the value range of the volume data for visualization on the display; and
a function module for changing the image for volume data of the slice area in accordance with the distance of the slice area relative to a region bordering the slice area, wherein the image changes a volume region of the volume data for the visualization of the slice area on the display.

20. In a non-transitory computer-readable storage medium that stores instructions executable by one or more computing devices to visualize properties of an object as an image on a display, the instructions comprising:
visualizing the object using volume data;
defining at least one slice area in accordance with slice information within the volume data;
using an image of a value range of the volume data for visualization on the display; and
changing the image for volume data of the at least one slice area in accordance with a distance of the at least one slice area relative to a region of volume data bordering the slice area.
